(19) United States
(12) Patent Application Publication
(10) Pub. No.: US 2004/0066272 A1
(43) Pub. Date: Apr. 8, 2004

(54) House code assigning device for assigning house code to electronic equipment

(75) Inventors: Katsumi Kitagaki, Hyogo (JP); Takashi Hirosawa, Tokyo (JP); Harufusa Kondoh, Tokyo (JP); Kiyoshi Nakakimura, Tokyo (JP)

Correspondence Address: BURNS, DOANE, SWECKER & MATHIS, L.L.P., P.O. Box 1404, Alexandria, VA, 22313-1404, US

(73) Assignees: RENESAS TECHNOLOGY CORPORATION; RENESAS LSI DESIGN CORPORATION

(21) Appl. No.: 10/603,663

(22) Filed: Jun. 26, 2003

(30) Foreign Application Priority Data
Sep. 20, 2002 (JP) 2002-275536

(51) Int. Cl. G05B 23/02

(52) U.S. Cl. 340/3.1; 700/1

(57) ABSTRACT

A house code assigning device includes a communication unit for sending a command for requesting transmission of a house code to electronic equipment included in a system and for receiving a house code from the electronic equipment, a verification unit for verifying whether or not a house code received by the communication unit is correct and for outputting a verification result showing whether or not the house code received by the communication unit is correct, and a display control unit for controlling a light emitting unit according to the verification result from the verification unit.

### BACKGROUND OF THE INVENTION

1. Field of the Invention

The present invention relates to a house code assigning device for assigning a house code to electronic equipment.

2. Description of Related Art

There is a method of superimposing control signals over electric power lines as a communication method that implements a home network system for controlling electronic equipment for use at home. This method can control each electronic equipment for use at home that is included in the home network system by superimposing control signals over electric power lines via which electric power is supplied to each home. In this case, a specific house code is assigned to each home's system in order to control the system independently of all other homes' systems. In other words, in accordance with the prior art method, a house code used for identifying each home's system is added to data included in control signals for controlling the system so that the system can be controlled independently of all other homes' systems. To this end, a house code assigning switch, such as a DIP switch, is disposed in each electronic equipment included in each home's system, and users are therefore allowed to assign a common house code to each home's system by operating the house code assigning switch.

A problem encountered with the prior art method of assigning a house code to each electronic equipment included in each home's system by using a DIP switch disposed in each electronic equipment is that users have to perform complex house code assigning operations and may assign an incorrect house code to each electronic equipment included in each home's system. In recent years, methods of connecting a house code assigning device to target electronic equipment, and transmitting a house code to the electronic equipment so as to assign the house code to the electronic equipment have been used. For example, Japanese patent application publication (TOKKAIHEI) No. 8-223092 discloses a system in which users are allowed to operate a house code assigning switch that is disposed in a main phone (corresponding to a house code assigning device), so as to assign a house code to the main phone, and users are also allowed to operate a house code message sending switch that is disposed in the main phone so as to transmit a message including the house code to a cordless handset (corresponding to electronic equipment).

A problem with a prior art house code assigning device constructed as mentioned above is that it is impossible to promptly and surely determine whether or not the house code set to each electronic equipment included in each home's system is correct. When a house code transmitted from the house code assigning device is erroneously assigned to electronic equipment due to a poor connection between the house code assigning device and the electronic equipment, an influence of noise, or the like, it is difficult to determine whether or not the house code assigned to the electronic equipment is correct as long as the electronic equipment does not malfunction explicitly.

As previously mentioned, a problem encountered with a prior art house code assigning method of assigning a house code to each electronic equipment included in each home's system by using a house code assigning switch disposed in each electronic equipment is that users have to connect a house code assigning device to target electronic equipment and perform complex house code assigning operations by using the house code assigning switch. For example, in the case of Japanese patent application publication (TOKKAIHEI) No. 8-223092, after connecting the main phone to a target cordless handset, users have to operate the house code message sending switch of the main phone so as to assign the house code to the cordless handset, and users have to perform complex house code assigning operations every time when the number of pieces of electronic equipment included in the system increases.

### SUMMARY OF THE INVENTION

The present invention is proposed to solve the above-mentioned problems, and it is therefore an object of the present invention to provide a house code assigning device capable of promptly, surely verifying whether or not a house code assigned to electronic equipment is correct.

It is another object of the present invention to provide a house code assigning device capable of reducing the load of assigning a house code to electronic equipment.

In accordance with an aspect of the present invention, there is provided a house code assigning device including: a communication unit for sending a house code transmission request command for requesting transmission of a house code to electronic equipment included in a system and for receiving a house code from the electronic equipment; a verification unit for verifying whether or not a house code received by the communication unit is correct and for outputting a verification result showing whether or not the house code received by the communication unit is correct; and a display control unit for controlling a light emitting unit according to the verification result from the verification unit.

As a result, users can promptly, surely verify whether or not the house code assigned to arbitrary electronic equipment is correct.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing the structure of a system that employs a house code assigning device according to embodiment 1 of the present invention;

FIG. 2 is a flow chart showing a control process performed by a controller of the house code assigning device according to embodiment 1;

FIG. 3 is a flow chart showing a control process performed by a controller of electronic equipment included in the system shown in FIG. 1;

FIG. 4 is a block diagram showing the structure of a system that employs a house code assigning device according to embodiment 2 of the present invention;

FIG. 5 is a flow chart showing a control process performed by a controller of a house code assigning device according to embodiment 3 of the present invention;

FIG. 6 is a diagram showing the structure of a private line for connecting the house code assigning device according to embodiment 3 with electronic equipment; and

FIG. 7 is a diagram showing the structure of part of the house code assigning device according to embodiment 3, which detects a load current flowing into the electronic equipment connected to the house code assigning device.

### DETAILED DESCRIPTION OF THE PREFERRED EMBODIMENTS

The invention will now be described with reference to the accompanying drawings.

Embodiment 1.

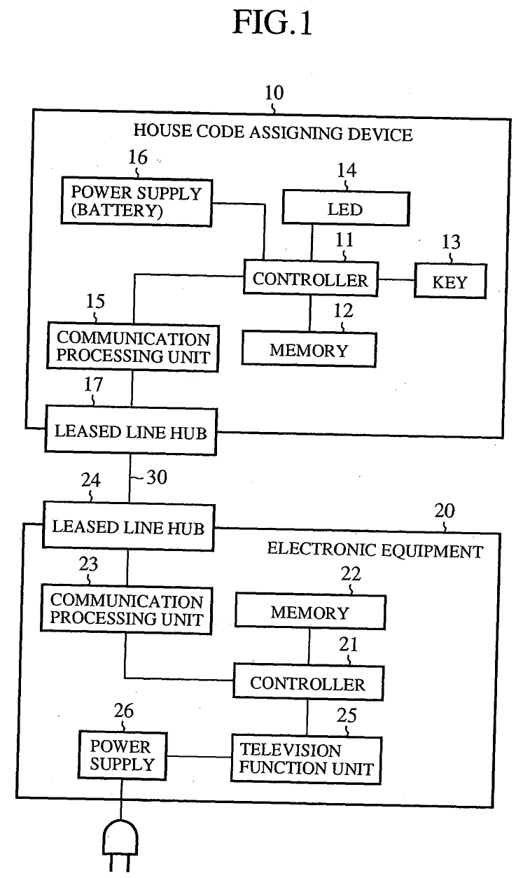

FIG. 1 is a block diagram showing the structure of a system that employs a house code assigning device in accordance with embodiment 1 of the present invention. In the figure, reference numeral 10 denotes the portable house code assigning device. The house code assigning device 10 is provided with a controller (communication means, verification means, and display control means) 10 for controlling the house code assigning device 10, a memory 12 for storing a multiple-bit house code that is to be assigned to target electric equipment included in the system, a key switch 13, an LED (light emitting means) 14, a communication processing unit (communication means) 15, a power supply 16 that is a battery, and a leased line hub 17. Reference numeral 20 denotes electronic equipment that is a household electrical appliance such as a television receiver. T he electronic equipment 20 is provided with a controller 21 for controlling the electronic equipment 20, a memory 22 for storing a house code assigned to the electronic equipment 20, a communication processing unit 23, a leased line hub 24, a television function unit 25, and a power supply unit 26 for receiving a supply of commercial power. Reference numeral 30 denotes a leased line that connects the house code assigning device 10 to the electronic equipment 20 and that works from a small amount of DC electrical power.

In addition to the electronic equipment 20 having the television function unit 25, other types of electronic equipment not shown in the figure (electronic equipment having an air conditioning function unit, electronic equipment having a fire detection function-unit and so on) can be disposed in the system. In general, a control line, such as a telephone wire, is connected to the leased line hub 24 so that each electronic equipment disposed in the system can be controlled by a device located outside each electronic equipment. In accordance with a radio low, a house code specific to the system is included in control data transmitted in the system and, when there is a match between the house code of electronic equipment and that included in control data transmitted to the electronic equipment, communications can be established between the electronic equipment and a control device that controls the electronic equipment by using the control data. In order to assign a house code to arbitrary electronic equipment included in the system, the control line is detached from the leased line hub 24 of the electronic equipment and the leased line 30 is connected to the leased line hub 24 so that the house code assigning device 10 can communicate with the electronic equipment by way of the leased line 30.

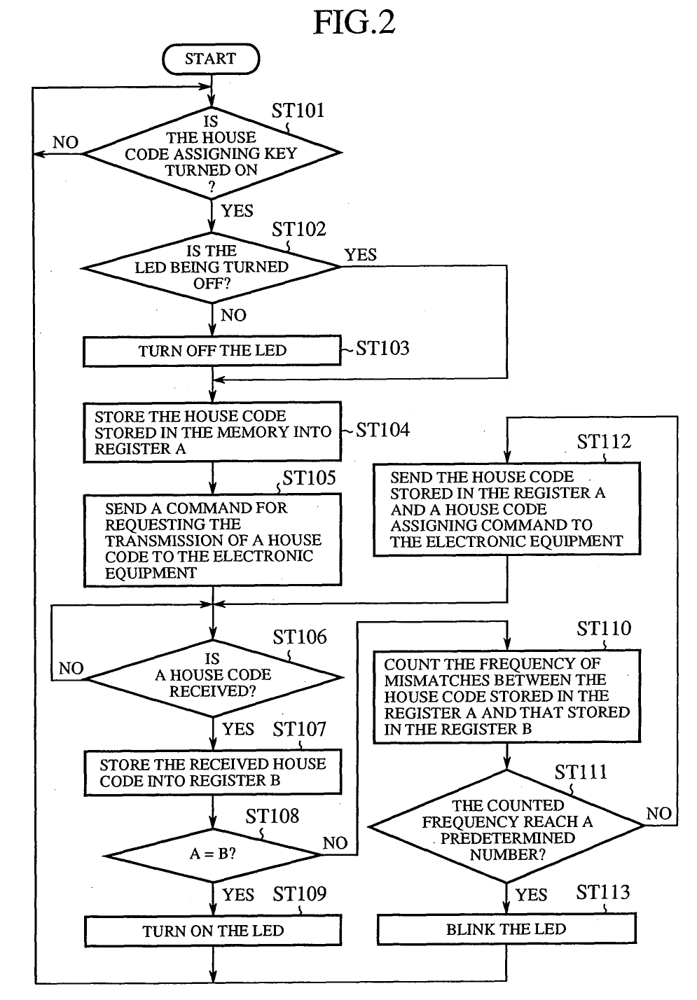

Next, a description will be made as to an operation of the house code assigning device 10. FIG. 2 is a flow chart showing control processing performed by the controller 11 of the house code assigning device 10. The controller 11 determines whether or not a house code assigning key is pushed (in step ST101). When determining that the house code assigning key is pushed, the controller 11 further determines whether or not the LED 14 is being turned off (in step ST102). When the LED 14 is being turned on or is blinking, the controller 11 turns off the LED 14 (in step ST103). The controller 11 then stores the house code stored in the memory 12 into a register A thereof (in step ST104). After that, the controller 11 sends a house code transmission request command for requesting the transmission of a house code to the electronic equipment 20 (in step ST105), and waits for reception of a house code from the electronic equipment 20 (in step ST106).

When receiving a house code from the electronic equipment 20 by way of the communication processing unit 15, the controller 11 of the house code assigning device 10 stores the received house code into a register B thereof (in step ST107). The controller 11 determines whether or not there is a match between the house code stored in the register A and that stored in the register B (in step ST108). When there is a match between the house code stored in the register A and that stored in the register B, the controller 11 turns on the LED 14 (in step ST109) so as to notify users that the house code set to the electronic equipment 20 is correct. On the other hand, when there is a mismatch between the house code stored in the register A and that stored in the register B, the controller 11 increments a count value representing the frequency of mismatches between those house codes by 1 (in step ST110).

When the electronic equipment 20 is built into the system for the first time, no specific house code is stored in the memory 22 of the electronic equipment 20. For example, when initial data with all bits set to “0” or “1” are stored in the memory 22 of the electronic equipment 20 when the electronic equipment 20 is shipped. On the other hand, when the electronic equipment 20 is transferred to the system from another system, a house code specific to the other system is stored in the memory 22 of the electronic equipment 20. Therefore, when the electronic equipment 20 is built into the system for the first time and when the electronic equipment 20 is transferred to the system from another system, there is a mismatch between the house code assigned to the system and that stored in the memory 22 of the electronic equipment 20. The count value representing the frequency of mismatches between the house code stored in the register A and that stored in the register B is initially set to zero.

The controller 11 then determines whether the frequency of mismatches between the house code stored in the register A and that stored in the register B reaches a predetermined number of times (for example, 10 times) (in step ST111) when there is a mismatch between those house codes. When the frequency of mismatches between the house code stored in the register A and that stored in the register B does not reach the predetermined number of times, the controller 11 transmits the house code stored in the register A and a house code assigning command for assigning the house code to the electronic equipment 20 (in step ST112). In otherwords, the controller 11 transmits the correct house code specific to the system and the house code assigning command for assigning the house code to the electronic equipment 20 to the electronic equipment 20. The controller 11 then advances to step ST106 in which it waits for reception of a house code from the electronic equipment 20. In other words, the controller 11 waits for reception of the house code newly stored in the memory 22 of the electronic equipment 20 in order to check to see whether the correct house code has been stored in the memory 22 of the electronic equipment 20.

When the electronic equipment 20 is built into the system for the first time or when the electronic equipment 20 is transferred to the system from another system, if there is neither communications failure nor influence of noise, the correct house code must be set to the memory 22 of the electronic equipment 20 after the controller 11 performs the process of step ST112. Therefore, there is a match between the house code received in step ST107 and stored into the register B and the house code stored in to the register A, i.e., the correct house code transmitted to the electronic equipment 20. In this case, the controller 11 turns on the LED 14 in step ST109 so as to notify users that the house code set to the electronic equipment 20 is correct.

However, if there is a communications failure or an influence of noise, there is a possibility that the correct house code is not assigned to the memory 22 of the electronic equipment 20. In such a case, because there is a mismatch between the house code assigned to the electronic equipment 20 and the correct house code transmitted to the electronic equipment 20, the controller 11 shifts from step ST108 to step ST110 in which it increments the count value representing the frequency of mismatches between the house code stored in the register A and that stored in the register B by 1. When the frequency of mismatches reaches the predetermined number of times, that is, when the correct house code cannot be stored into the memory 22 of the electronic equipment 20 even if the correct house code is transmitted to the electronic equipment 20 the predetermined number of times, the controller 11 blinks the LED 14 (in step ST113) so as to notify users that the house code assigned to the electronic equipment 20 is incorrect. In other words, the controller 11 notifies users that the house code assigning has failed.

If the count value representing the frequency of mismatches between the house code stored in the register A and that stored in the register B is not “0” after the LED 14 is turned on or is made to blink, the count value is reset to “0” in preparation for new house code assigning (not shown in the flow chart of FIG. 2).

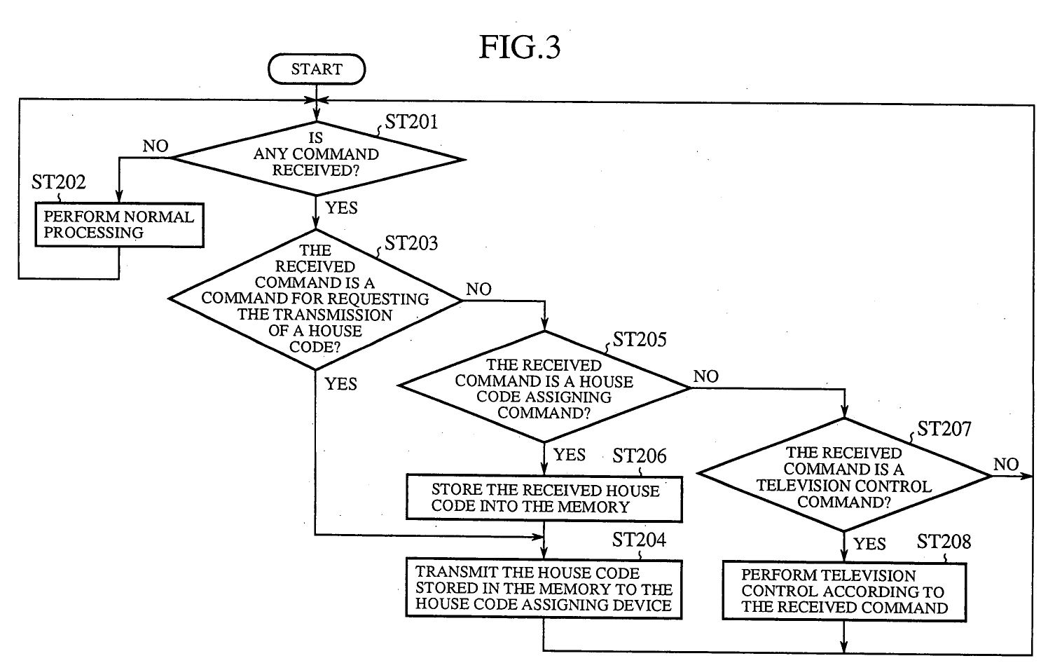

FIG. 3 is a flow chart showing control processing performed by the controller 21 of the electronic equipment 20. First of all, the controller 21 determines whether it receives a command from outside the electronic equipment 20 by way of the leased line hub 24 and the communication processing unit 23 (in step ST201). When receiving no command, the controller 21 carries out normal processing (in step ST202). The normal processing includes controlling of the television function unit 54, monitoring whether anomalies occur in the power supply, and so on. When receiving a command, the controller 21 determines whether or not the received command is a house code transmission request command for requesting the transmission of a house code that is sent from the house code assigning device 10 (in step ST203). When the received command is a house code transmission request command, the controller 11 reads the house code stored in the memory 22 and transmits it to the house code assigning device 10 by way of the leased line 30 (in step ST204).

When the received command is not a house code transmission request command, the controller 11 further determines whether or not the received command is a house code assigning command (in step ST205). When the received command is a house code assigning command, the controller 11 stores a house code (i.e., the correct house code), which is received together with the house code assigning command, into the memory 22 (in step ST206). The controller 11 then reads the stored house code and transmits it to the house code assigning device 10 by way of the leased line 30 (in step ST204).

When the received command is neither a house code transmission request command nor a house code assigning command, the controller 11 further determines whether or not the received command is a television control command (in step ST207). When the received command is a television control command, the controller 11 performs television control processing according to the command (in step,ST208). For example, when receiving a television control command for recording a television program on a specified channel that will be broadcasted during a specified time period on VTR, the controller 11 performs recording processing according to the television control command.

As mentioned above, in accordance with this embodiment 1, because the controller 11 of the house code assigning device 10 turns on the LED 14 when the house code assigned to the electronic equipment 20 is correct, and blinks the LED 14 otherwise, users are allowed to promptly, surely verify whether or not the house code assigned to the electronic equipment 20 is correct.

Furthermore, in accordance with this embodiment 1, the controller 11 of the house code assigning device 10 transmits the correct house code and the house code assigning command to the electronic equipment 20 when the house code received by the communication processing unit 15 is incorrect, and also outputs a verification result showing that the house code assigned to the electronic equipment 20 is incorrect when the house code received from the electronic equipment 20 is incorrect after the correct house code and the house code assigning command have been transmitted to the electronic equipment 20 a predetermined number of times. Therefore, even when the correct house code cannot be assigned to the electronic equipment 20 due to noise that occurs by accident, the house code assigning device 10 can assign the correct house code to the electronic equipment 20 with a high probability by repeating the house code assigning process.

In addition, in accordance with this embodiment 1, because the house code assigning device 10 can send and receive the house code, the house code transmission request command, and the house code assigning command to and from the electronic equipment 20 connected thereto by way of the leased line 30 that works from a small amount of DC electrical power, the house code assigning device 10 can be portable and can work from the battery 16.

Embodiment 2.

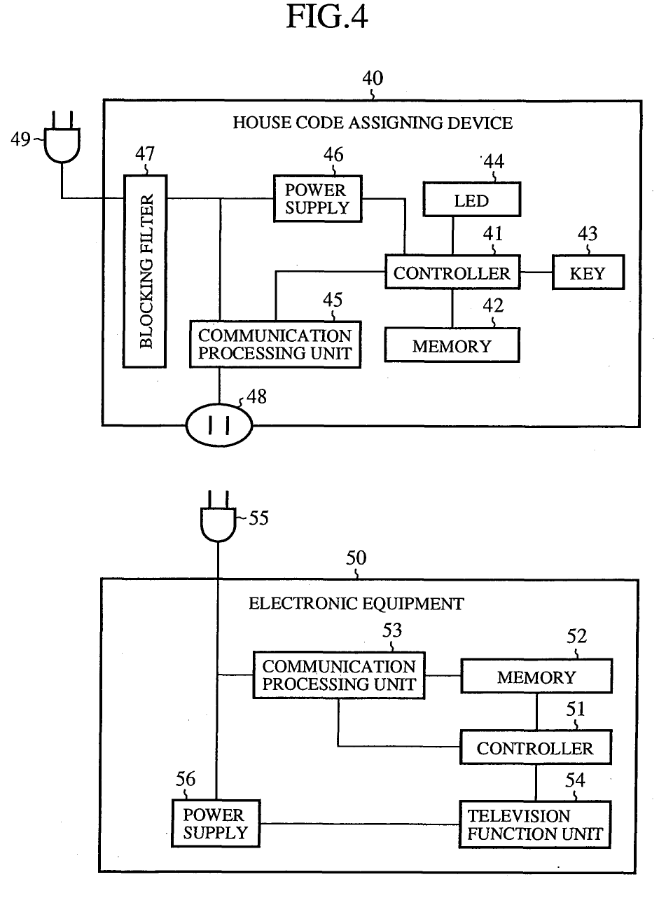

FIG. 4 is a block diagram showing the structure of a system that employs a house code assigning device according to embodiment 2 of the present invention. The house code assigning device 40 is provided with a controller (communication means, verification means, and display control means) 41 for controlling the house code assigning device 40, a memory 42 for storing a house code to be assigned to electronic equipment, a key switch 43, an LED (light emitting means) 44, a communication processing unit (communication means) 45, a power supply 46 that receives a supply of commercial power, a blocking filter 47, a power supply receptacle 48, and a power plug 49. Electronic equipment 50 that is a household electrical appliance such as a television receiver is provided with a controller 51 for controlling the electronic equipment 50, a memory 52 for storing a house code assigned to the electronic equipment 50, a communication processing unit 53, a television function unit 54, a power plug 55 that can be connected to either the power supply receptacle 48 of the house code assigning device 40 or a commercial power supply receptacle, and a power supply 56 that receives a supply of electrical power acquired via the power plug 55.

As in the case of above-mentioned embodiment 1, in addition to the electronic equipment 50 having the television function unit 54, other types of electronic equipment not shown in the figure (electronic equipment having an air conditioning function unit, electronic equipment having a fire detection function unit and so on) can be disposed in the system. In general, the power plug 55 is connected to commercial power lines so that each electronic equipment disposed in the system can be controlled by a device located outside each electronic equipment. In this case, control data are transmitted between the house code assigning device and each electronic equipment while they are superimposed over the commercial power lines. In accordance with a radio low, a house code specific to the system is included in control data transmitted in the system and, when there is a match between the house code of electronic equipment and that included in control data transmitted to the electronic equipment, communications can be established between the electronic equipment and a control device that controls the electronic equipment by using the control data. In order to assign a house code to arbitrary electronic equipment included in the system, the power plug 55 of the electronic equipment is detached from the commercial power lines and is then connected to the power supply receptacle 48 of the house code assigning device 40 so that the house code assigning device 40 can communicate with the electronic equipment by way of the commercial power lines. The blocking filter 47 is so disposed as to prevent influences from being exerted on any other electronic equipment included in the system. In other words; while the blocking filter 47 allows commercial power to pass therethrough with little loss, the blocking filter 47 interrupts house codes and various commands.

Next, a description will be made as to an operation of the house code assigning device according to embodiment 2 of the present invention. When a user connects the power plug 49 of the house code assigning device 40 to commercial power lines, electrical power that passes through the blocking filter 47 is supplied to the power supply 46 and the house code assigning device 40 can be started up. When the user then connects the power plug 55 of the electronic equipment 50 to the power supply receptacle 48 of the house code assigning device 40, electrical power supplied to the house code assigning device 40 is supplied to the power supply 56 of the electronic equipment 50. As a result, the controller 41 of the house code assigning device 40 carries out control processing, and the controller 51 of the electronic equipment 50 carries out control processing. The control processing performed by the controller 41 is the same as that shown in the flow chart of FIG. 2, and the control processing performed by the controller 51 is the same as that shown in the flow chart of FIG. 3.

As mentioned above, in accordance with this embodiment 2, because the controller 41 of the house code assigning device 40 turns on the LED 44 when the house code assigned to the electronic equipment 50 is correct, and blinks the LED 44 otherwise, like that of above-mentioned embodiment 1, users are allowed to promptly, surely verify whether or not the house code assigned to the electronic equipment 50 is correct.

Furthermore, in accordance with this embodiment 2, the controller 41 of the house code assigning device 40 transmits the correct house code and a house code assigning command to the electronic equipment 50 when the house code received by the communication processing unit 45 is incorrect, and also outputs a verification result showing that the house code assigned to the electronic equipment 50 is incorrect when the house code received from the electronic equipment 50 is incorrect after the correct house code and a house code assigning command have been transmitted to the electronic equipment 50 a predetermined number of times, like that of above-mentioned embodiment 1. Therefore, even when the correct house code cannot be assigned to the electronic equipment 50 due to noise that occurs by accident, the house code assigning device 40 can assign the correct house code to the electronic equipment 50 with a high probability by repeating the house code assigning processing.

In addition, in accordance with this embodiment 2, because the house code assigning device 40 can send and receive the house code, the house code transmission request command, and the house code assigning command to and from the electronic equipment 50 connected thereto by way of commercial power lines via which electrical power is supplied to the electronic equipment 50, sending and receiving of control signals, such as the house code, the house code transmission request command, and the house code assigning command, can be implemented with efficiency between the house code assigning device 40 and the electronic equipments 50 because they are superimposed over commercial power lines.

Embodiment 3.

While a house code assigning device according to embodiment 3 of the present invention has the same structure as that according to embodiment 1 or embodiment 2, a controller of the house code assigning device performs control processing different from those performed by the controllers of embodiment 1 and embodiment 2. Therefore, the explanation of the structure of the house code assigning device according to embodiment 3 will be omitted hereafter.

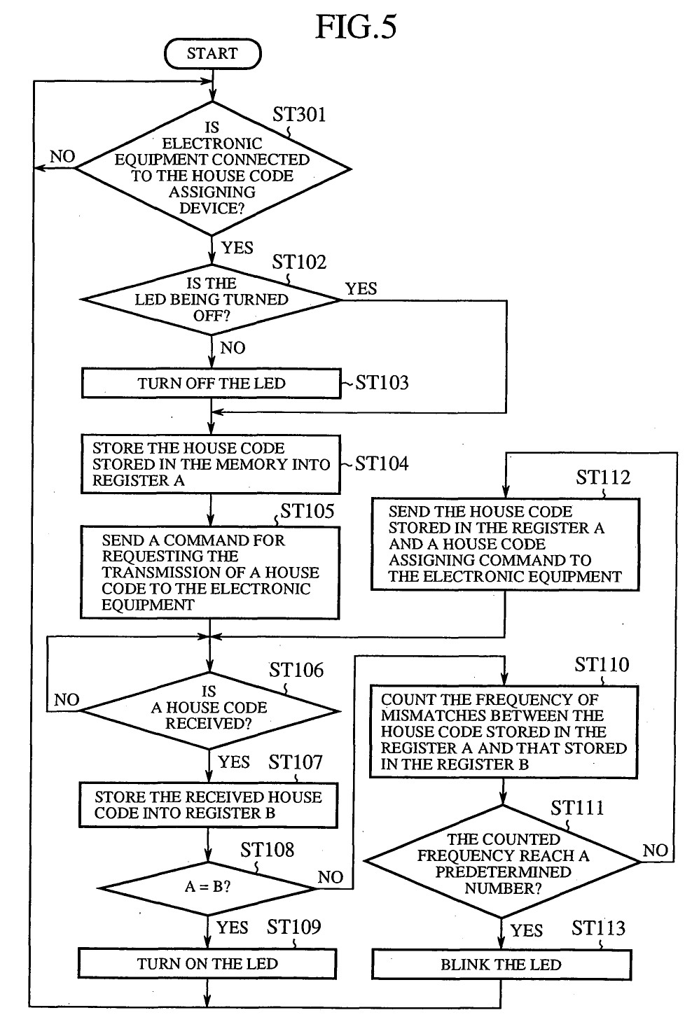

Next, a description will be made as to an operation of the house code assigning device according to embodiment 3 of the present invention. FIG. 5 is a flow chart showing control processing performed by the controller of the house code assigning device. Processes of all steps but the first step ST301 shown in this flow chart are the same as the processes shown in the flowchart of FIG. 2, respectively. The controller of the house code assigning device determines whether or not a certain piece of electronic equipment is newly connected to the house code assigning device, in step. ST301. When determining (or making sure) that a certain piece of electronic equipment is newly connected to the house code assigning device, the controller automatically performs the processes in steps ST102 to ST113 without requiring any key switch operations. In other words, the controller transmits a house code transmission request command for requesting the transmission of a house code to the electronic equipment, and then receives a house code assigned to the electronic equipment.

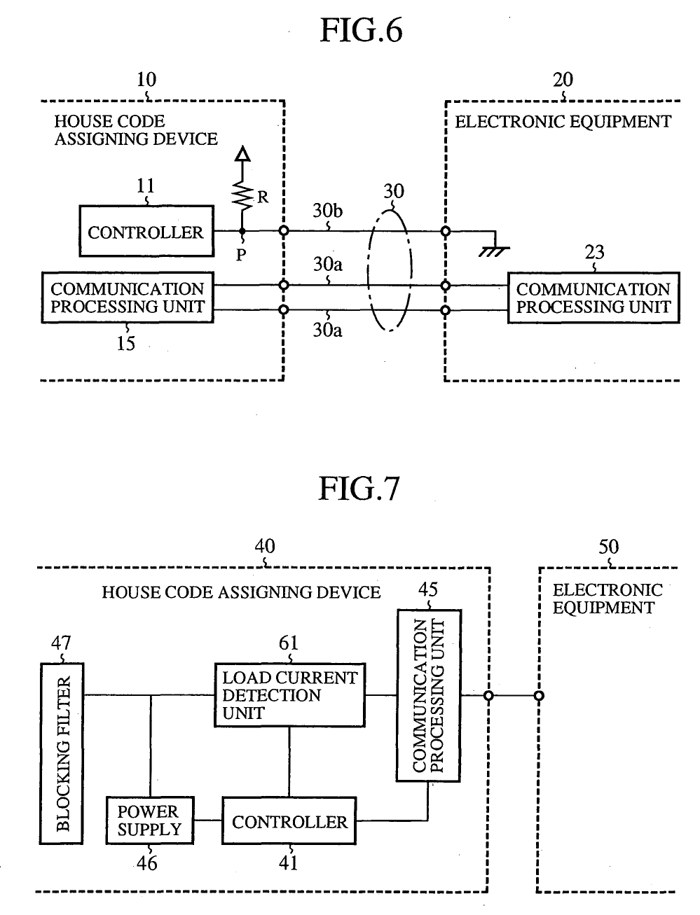

For example, the house code assigning device according to embodiment 3 can have a structure as shown in FIG. 6, like that of above-mentioned embodiment 1. Only components associated with the connection between the house code assigning device 10 and the electronic equipment 20 are illustrated in FIG. 6. In this case, a leased line 30 for connecting the house code assigning device 10 to the electronic equipment 20 is disposed, the leased line 30 including a detection line 30b used for detecting a connection between the house code assigning device 10 and the electronic equipment 20 in addition to signal lines 30a via which a house code and so on are transmitted. The controller 11 can determine whether or not the electronic equipment 20 is connected to the leased line 30 by detecting a potential at a point P, which is pulled up by a resistor R. In this example, the controller 11 determines that the electronic equipment 20 is not connected to the house code assigning device 10 when the potential at the point P is high, and determines that the electronic equipment 20 is connected to the house code assigning device 10 otherwise.

The house code assigning device according to embodiment 3 can have a structure as shown in FIG. 7, like that of above-mentioned embodiment 2. Only components associated with the connection between the house code assigning device 40 and the electronic equipment 50 are illustrated in FIG. 7. In FIG. 7, reference numeral 61 denotes a load current detecting unit disposed between the blocking filter 47 and the communication processing unit 45. The controller 41 can determine whether or not the electronic equipment 50 is connected to the house code assigning device 40 by detecting a load current that flows into the electronic equipment 50 by using the load current detecting unit 61. In otherwords, the controller 41 determines that the electronic equipment 50 is not connected to the house code assigning device 40 when not detecting a predetermined amount of load current flowing into the electronic equipment 50, and determines that the electronic equipment 50 is connected to the house code assigning device 40 otherwise.

As mentioned above, in accordance with this embodiment 3, the house code assigning device can transmit a house code transmission request command for requesting the transmission of a house code to arbitrary electronic equipment, and receive a house code assigned to the electronic equipment when determining that the arbitrary electronic equipment is connected thereto, thereby reducing the load of assigning a house code to arbitrary electronic equipment.

Many widely different embodiments of the present invention may be constructed without departing from the spirit and scope of the present invention. It should be understood that the present invention is not limited to the specific embodiments described in the specification, except as defined in the appended claims.

What is claimed is:

1. A house code assigning device for assigning a specific house code to one or more pieces of electronic equipment connected with each other via a common line in order to differentiate a system, in which the one or more pieces of electronic equipment are controlled through communication via the common line, from other systems, said device comprising:
a communication means for sending a command for requesting transmission of a house code to electronic equipment included in the system and for receiving a house code from the electronic equipment;
a verification means for verifying whether or not a house code received by said communication means is correct and for outputting a verification result showing whether or not the house code received by said communication means is correct; and
a display control means for controlling a light emitting means according to the verification result from said verification means.

2. The house code assigning device according to claim 1, wherein said display control means turns on said light emitting means when the verification result shows that the house code received by said communication means is correct, whereas said display control means blinks said light emitting means when the verification result shows that the house code received by said communication means is incorrect.

3. The house code assigning device according to claim 1, wherein every time when said verification means determines that the house code received by said communication means is incorrect, said verification means causes said communication means to send a correct house code and a house code assigning command for assigning the correct house code to said electronic equipment, counts a number of times that said verification means verifies that the house code received by said communication means is incorrect, and outputs a verification result showing that the house code received by said communication means is incorrect when determining that the house code received by said communication means is incorrect after the number of times that said verification means verifies that the house code received by said communication means is incorrect reaches a predetermined number of times.

4. The house code assigning device according to claim 1, wherein when said house code assigning device makes sure that a certain piece of electronic equipment is newly connected to the house code assigning device, said communication means sends a command for requesting transmission of a house code to said electronic equipment and receives a house code assigned to said electronic equipment.

5. The house code assigning device according to claim 1, wherein said communication means can send a house code, a house code transmission request command for requesting transmission of a house code, and a house code assigning command for assigning a house code, and can receive a house code to and from electronic equipment connected to said house code assigning device, by way of a leased line that works from a small amount of DC electrical power.

6. The house code assigning device according to claim 1, wherein said communication means can send a house code, a house code transmission request command for requesting transmission of a house code, and a house code assigning command for assigning a house code, and can receive a house code to and from electronic equipment connected to said house code assigning device, by way of electrical power lines via which electrical power is supplied to the electronic equipment.
